(19) United States
(12) Patent Application Publication
(10) Pub. No.: US 2021/0081750 A1
(43) Pub. Date: Mar. 18, 2021

(54) METHOD AND SYSTEM FOR NEGOTIATION IN MULTI-AGENT OPTIMIZATION

(71) Applicant: NEC Laboratories Europe GmbH, Heidelberg (DE)

(72) Inventor: Tobias Jacobs, Mannheim (DE)

(21) Appl. No.: 16/571,305

(22) Filed: Sep. 16, 2019

(51) Int. Cl. G06N 3/00; G06N 5/04

(52) U.S. Cl. CPC G06N 3/006; G06N 5/043

(57) ABSTRACT

A method for negotiating a solution to a joint optimization problem includes: transmitting a machine-readable constraint proposal specifying one or more machine-readable constraints to each of a plurality of agents; and receiving, from each of the plurality of agents, a machine-readable counter-proposal specifying one or more additional or alternative machine-readable constraints. The method further includes computing a solution compatible with each of the one or more machine-readable constraints and the one or more additional or alternative machine-readable constraints; and communicating, to each of the plurality of agents via a machine-to-machine protocol, the computed solution.

### FIELD

The present invention relates to computational optimization, and in particular, to computational optimization in the context of negotiating solutions to joint optimization problems.

### STATEMENT OF FUNDING

This project has received funding from the European Union's Horizon 2020 research and innovation programme under grant agreement No. 769141.

### BACKGROUND

In situations where multiple entities (i.e. agents) need to agree on a common solution to an optimization problem, when a proposed solution is presented to one such entity, said entity may wish to verify that there is no solution in a solution space that is both better for said entity than the proposed solution and equally fair to the other entities. In such situations, the entities can often (a) have different interests (objectives) and (b) have limited computational capabilities resulting in them being dependent on other entities to perform computational optimizations-even though they do not necessarily trust those other entities. Such situations often arise, for example, in logistics operations involving multiple stakeholders (e.g. companies, drivers, customers, etc.).

Terelius (i.e. Terelius, Häkan, Ufuk Topcu, and Richard M. Murray. “Decentralized multi-agent optimization via dual decomposition.” IFAC proceedings volumes 44.1 (2011): 11245-11251.), which is hereby incorporated by reference herein, describes multi-agent optimization in situations where individual agents only possess local information.

Furthermore, in Wangerman (i.e. Wangerman, John P., and Robert F. Stengel. “Optimization and coordination of multiagent systems using principled negotiation.” Journal of Guidance, Control, and Dynamics 22.1 (1999): 43-50.), which is hereby incorporated by reference herein, a mechanism for principled negotiation between agents is proposed. However, in the mechanism described by Wangerman, negotiation is based on the proposal and counter-proposal of full action plans, and finding a solution is likely to take many rounds negotiation. As a result, each agent has the computationally intensive burden of computing full action plans at each round of the negotiation in order to participate in the negotiation.

U.S. Patent Application Publication No. 2017/0061386 describes an automatic scheduling system that negotiates with recipients to find important conditions or constraints. However, the automatic scheduling system described therein is limited to finding suitable schedules for a number of recipients, and the constraints described therein only represent simple availability information regarding the participants in specific time slots. Therefore, the automatic scheduling system described therein cannot be utilized in more complex situations such as those presented in logistics or public transport applications. Furthermore, the automatic scheduling system described therein is limited to finding a suitable schedule purely through constraint satisfaction techniques and cannot be applied for negotiating a solution to an optimization problem with objective functions.

### SUMMARY

In an embodiment, the present invention provides a method for negotiating a solution to a joint optimization problem, which includes: transmitting a machine-readable constraint proposal specifying one or more machine-readable constraints to each of a plurality of agents; and receiving, from each of the plurality of agents, a machine-readable counter-proposal specifying one or more additional or alternative machine-readable constraints. The method further includes computing a solution compatible with each of the one or more machine-readable constraints and the one or more additional or alternative machine-readable constraints; and communicating, to each of the plurality of agents via a machine-to-machine protocol, the computed solution.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic diagram of an environment in which a protocol for negotiating a solution to an optimization problem can be executed;

FIG. 2 is a flow chart illustrating a protocol for negotiating a solution to an optimization problem;

FIG. 3 is a schematic diagram of an alternative environment in which a protocol for negotiating a solution to an optimization problem can be executed; and

FIG. 4 is a flow chart illustrating an alternative protocol for negotiating a solution to an optimization problem.

### DETAILED DESCRIPTION

According to embodiments of the invention, sets of messages are defined that can be transmitted between agents to ensure fairness and verifiability of solution.

According to embodiments of the invention, multi-agent communication methodologies are provided that enable agents to negotiate a solution to a joint optimization problem with or without fairness constraints, and with or without individual objective functions of the agents. In an embodiment, a central tool is to transfer, between the agents, information that provides one or more of (a) additional constraints of the optimization problem and (b) dual solutions as certificates of non-existence of certain solutions.

According to embodiments of the invention, a method is provided for negotiating a solution to a joint optimization problem. The method includes transmitting a machine-readable constraint proposal specifying one or more machine-readable constraints to each of a plurality of agents, receiving, from each of the plurality of agents, a machine-readable counter-proposal specifying one or more additional or alternative machine-readable constraints, and computing a solution compatible with each of the one or more machine-readable constraints and the one or more additional or alternative machine-readable constraints. The method also includes communicating, to each of the plurality of agents via a machine-to-machine protocol, the computed solution.

In an embodiment the method can further include receiving, from a respective one of the plurality of agents, a respective machine-readable counter-proposal specifying a machine-readable problematic constraint. The machine-readable problematic constraint is a constraint that will unnecessarily increase a cost of the solution to the joint optimization problem. The problematic constraint is a constraint that is in addition to the one or more additional or alternative constraints. The computed solution can be a solution that does not satisfy the machine-readable problematic constraint.

In an embodiment, the method can further include transmitting, to the respective one of the plurality of agents, a dual solution that includes the machine-readable problematic constraint. The dual solution can, for example, enable the respective one of the plurality of agents to verify, without computing a primal solution to the optimization problem, that the problematic machine-readable constraint will unnecessarily increase a cost of the solution to the joint optimization problem. The dual solution can, for example, be a certificate of the non-existence of a solution that both satisfies the machine-readable problematic constraint and has a decreased cost relative to the computed solution. The dual solution can, for example, define a set of functions that can be added to the used to simplify the joint optimization problem to a simplified joint optimization problem.

In an embodiment, determining a primal solution the joint optimization problem has a time dependence on a number of tasks to be performed that is exponential, and determining a primal solution to the simplified joint optimization problem has a time dependence on a number of tasks to be performed that is linear.

In an embodiment, the joint optimization problem is defined by a set of variables, an objective function to be minimized, and a set of constraint predicates. The one or more machine-readable constraints of the machine-readable constraint proposal can be in addition to constraints of the set of constraint predicates.

In an embodiment, the method further includes translating at least a portion of the one or more machine-readable constraints into a human-readable format and displaying the translated constraints on a user interface. In an embodiment, the method further includes receiving user input via the user interface and translating the user input into at least a portion of the one or more additional or alternative machine-readable constraints. The at least a portion of the one or more machine-readable constraints that is translated into a human-readable format can be, for example, selected based on a list of translatable constraints stored at a database.

According to embodiments of the invention, a non-transitory computer readable medium is provided having instructions stored thereon for carrying out a method for negotiating a solution to a joint optimization problem. The method includes transmitting a machine-readable constraint proposal specifying one or more machine-readable constraints to each of a plurality of agents, receiving, from each of the plurality of agents, a machine-readable counter-proposal specifying one or more additional or alternative machine-readable constraints, and computing a solution compatible with each of the one or more machine-readable constraints and the one or more additional or alternative machine-readable constraints. The method also includes communicating, to each of the plurality of agents via a machine-to-machine protocol, the computed solution.

According to an embodiment of the invention, a coordinator agent configured to negotiate a solution to a joint optimization problem is provided. The coordinator agent includes one or more processors configured to transmit a machine-readable constraint proposal specifying one or more machine-readable constraints to each of a plurality of agents, receive, from each of the plurality of agents, a machine-readable counter-proposal specifying one or more additional or alternative machine-readable constraints, and compute a solution compatible with each of the one or more machine-readable constraints and the one or more additional or alternative machine-readable constraints. The one or more processor are further configured to communicate, to each of the plurality of agents via a machine-to-machine protocol, the computed solution.

In the context of this invention, a multi-agent optimization problem is characterized by a set of variables X, and a set of constraint predicates dom(X)→{true, false} that have to be satisfied by any feasible solution. The constraints can encode technical or logical feasibility requirements (e.g., each parcel must be picked up by exactly one delivery vehicle), or they can encode previously agreed fairness conditions (e.g., no vehicle is assigned to more than twice as many parcels compared to any other vehicle). Each agent A potentially has its own objective function U_{A}:X→IR, and we assume without loss of generality here that all objectives are minimization objectives. In an embodiment, the constraint predicates are initial constraints that are determined prior to the coordinator agent proposing the additional constraints C. In an embodiment, each of the constraint predicates are in the form A*x-b≥0.

In an embodiment, the following message payloads between agents are defined:

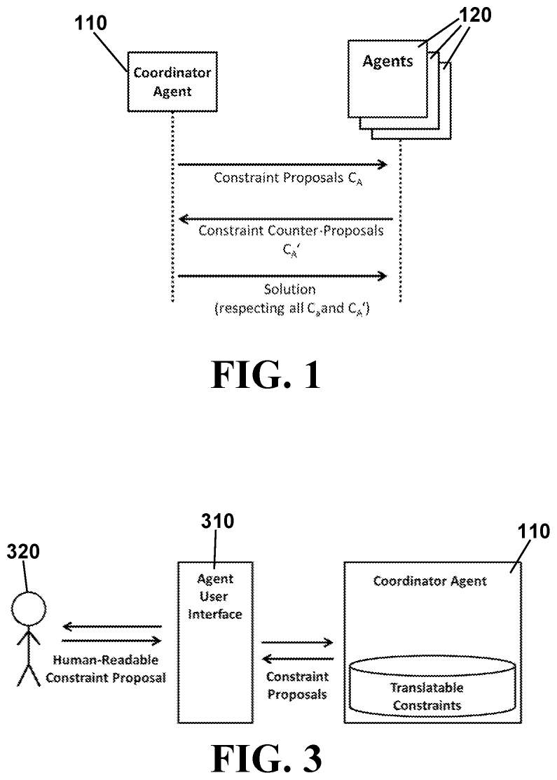

Constraint Proposal: an agent A proposes a set of additional constraints C:dom(X)→{true,false} to another agent B. Here, X is the set of variables over which the optimization problem is defined and C is the additional constraint proposed by the agent A. See, for example, FIG. 1. In a preferred embodiment, the constraint defines a property of the solution that agent B is requested to agree on, e.g. a set of tasks that B is requested to execute. The concept of constraint proposals include also the proposal of a complete solution to the given problem (e.g. by equality constraints setting each variable from X to a specific value).

Dual Solution Transmission: an agent A transmits a dual solution to agent B. In its most general form, a dual solution consists of a function for each constraint, where the function value is smaller than zero if and only if the constraint is violated. In an embodiment, the constraints are of the form Ax-b≥0, where x represents the input, A is a matrix, b is a vector, and the inequality (i.e., the above≥relationship) is component-wise. Here a dual solution can be represented as a vector u having the same dimensionality as b, and the corresponding constraint function is then defined as (Ax-b)*u, where the outer multiplication is component-wise. From the dual solution, a lower bound on the value of any (primal) solution satisfying all the constraints can be easily computed with respect to arbitrary objective functions. In a preferred embodiment, the dual solution having value v is used as an easily verifiable certificate that satisfying all constraints will result in no better than objective value v. In an embodiment, the dual solution having value v is a lowerbound value v, which is determined from solving a simplified optimization problem derived using the dual solution u.

In the field of computational optimization, dual solutions represent lower bounds on the value of an optimal primal solution. The primal solution is a solution in the common sense, i.e. an assignment of the variables in X to a set of values. A dual solution enables a much simpler optimization problem to be obtained. Specifically, a dual solution defines a set of functions that can be added to the optimization problem's objective function after all constraints have been removed thereby providing a simpler optimization problem. The best solution to the resulting simplified optimization problem represents a lower bound on the best solution to the original optimization problem. More specifically, the best solution which satisfies all constraints (that are covered by the dual solution) cannot have a value better than said lower bound.

Because the simplified optimization problem can be solved with little computational effort (e.g. in the case of linear optimization problems, solving the optimization problem exhibits linear time-dependence), agents that do not have extensive computational power can compute the lower bound from a given dual solution. As a result, they do not need to trust the correctness of the result presented by another agent.

According to an embodiment of the invention, a negotiation protocol is provided for determining a solution to a multi-agent optimization problem. In a first step, a specific agent, acting as the coordinator, sends a constraint proposal C_{A} to each of the other agents A involved in the optimization (encoding, for example, a set of tasks among which each agent is requested to execute a subset).

In a second step, each of the other agents either rejects the proposal or returns one or more further constraints to be satisfied. Each of the other agents A rejects the proposal if it will not accept any solution compatible with the proposed constraint proposal C_{A} (meaning, for example, that it will not execute any of the requested tasks). Alternatively, each of the other agents A sends back another constraint proposal C_{A}′ if a solution compatible with constraint proposal C_{A} will be accepted if the solution additionally satisfies the constraint proposal C_{A}′ (for example, the agent is willing to execute at most 3 of the proposed tasks).

In a third step, the coordinator, having received the responses, declares the negotiation process to have failed if some agent has rejected the proposal. Otherwise, it computes an optimal solution satisfying all C_{A} and C_{A}′. The solution it is then presented to all agents by a third constraint proposal. In situations where one of the agents has rejected the proposal in the second step or no feasible solution satisfying all C_{A} and C_{A}′ is found in the third step, the coordinator can either declare the negotiation process as failed, or can start again at the first step by providing a different constraint proposal C_{A} to the agents.

According to a second embodiment of the invention, after an agreed common objective function (e.g. to minimize the total cost) has been identified, a coordinator can collect constraint proposals from all agents (as in the second step of the previous embodiment). However, when some agent A proposes a constraint C whose satisfaction will lead to a high overall cost and there is an alternative solution with a much lower cost, then the coordinator can return the following information to A: (i) a cheaper alternative solution with value v′ that violates C and/or (ii) a dual solution to the original problem augmented with the proposed constraint C, whose value v is larger than the value v′ of the alternative solution. This pair of solutions certifies that the satisfying the proposed constraint C will unnecessarily increase the overall costs. Because the values of both primal and dual solutions are easy to compute, the agent A can efficiently verify the correctness without the need (a) to trust the correctness of the coordinator's computations and (b) to compute any primal or dual solution by itself. In an embodiment, a commonly agreed objective function is a prerequisite of the dual solutions process. In an embodiment, transmitting constraint proposals back and forth remains possible without a commonly agreed objective function.

According to a third embodiment of the invention, human feedback can be incorporated into the negotiation process. For example, humans (e.g. drivers of trucks) can be involved in a negotiation process whereby solution to an optimization problem is determined. As humans are, without extensive training, not able to process and understand generic constraints of optimization processes, the constraints need to be translated by a user interface and presented in a way that the human can make a decision about it or make a counterproposal. For example, the constraint proposal might be presented as a list of tasks, from which the human can select some subset or reject all of them. Because not all constraints can be translated in such a way, the coordinator agent in this embodiment has some database of translatable constraints, and it will only propose such types of constraints to the agent user interface.

According to embodiments, solutions are determined to logistics optimization problems are in which several participating service providers need to agree on a coordinated schedule for pickup and delivery of goods. In such cases, constraints represent proposals of which actor performs which tasks, and dual solutions represent certificates that prior proposals will lead to high costs. For example, a logistics optimization problem could be to minimize delivery cost subject to the following constraints: (a) each parcel gets picked up and delivered, and (b) each vehicle is on the road for no more than 8 hours. In the negotiation process, the coordinator agent presents to each vehicle a set of parcels to pick up and deliver in the form of a constraint. The vehicles can return, as a counter-proposal, a constraint which encodes a smaller subset of the proposed parcels to pickup and deliver.

According to embodiments of the invention, solutions are determined to logistics optimization problems for scenarios where multiple delivery service providers share some infrastructure and services. Such scenarios are not uncommon for logistics/postal companies-even when they are competing for customers in the same market segment and area. In some markets (e.g. postal services in some cities), sharing of infrastructure and services is even mandated by regulation. According to such embodiments, ad-hoc negotiations as to how to service upcoming pickup and delivery orders can be performed in a time-efficient manner. Here the common objective function can represent regulatory or contractually agreed upon key performance indicators (KPIs), e.g. an amount of emissions produced, or a total number of kilometers traveled. Constraints sent between the agents can be, e.g., price offers. For example, such a logistics optimization problem could be to minimize a total route traveled, subject to the constraint that all parcels are delivered without delay, i.e. within a specified period of time or before a specified delivery date and/or time. In identifying a solution to such an optimization problem, a first delivery company, or agent, A can make a proposal to a second delivery company, or agent, B, using a constraint that company A will deliver a subset of the parcels and company B will deliver the remaining parcels. Company B can make a constraint counter-proposal, demanding a compensation payment for delivering the parcels as proposed by company A.

According to further embodiments of the invention, a solution is determined to a public transport optimization problem in which multiple agents, e.g. a control center, on-demand buses, and taxis, negotiate to determine the specific aspects of a public transport service that each will provide. In said embodiments, constraints can be provided in the form of working times, kilometer limitations, and numbers of passengers to transport. Dual solutions can be used to show that satisfying constraints will lead to a larger amount of energy usage and longer transportation routes. For example, such a public transport optimization problem could be to minimize total CO2 emissions subject to the following constraints: (a) all passengers are transported to their demanded destination, and (b) none of the vehicles exceeds a specified passenger limit. A control center, acting as a coordinator agent, could propose to a specific vehicle to serve a specific set of customers. The vehicle might make a counter-proposal which consists of a constraint which limits its total kilometers to travel.

FIG. 1 is a schematic diagram of a system environment in which a protocol for negotiating a solution to an optimization problem can be executed. The system environment includes a coordinator agent 110 and a plurality of additional agents 120. The coordinator agent 110 and each of the plurality of additional agents 120 can be, e.g., one or more physical machines each including compute resources, storage resources, and network resources—or a component of such one or more physical machines. For example, each of the coordinator agent 110 and the plurality of additional agents 120 can be, e.g., a virtual machine (VM) or collection of VMs hosted by one or more physical machines. The compute resources of the physical machines include one or more processors each having one or more processor cores. The storage resources can include computer readable memory, e.g., random-access-memory (RAM) and/or cache memory. The network resources can include, e.g., a physical network interface controller. The coordinator agent 110 and each of the plurality of additional agents 120 can include, e.g., a set of processor executable instructions stored at a processor readable memory, e.g. a processor readable memory of the one or more physical machines, and configured to be executed by a processor, e.g. a processor or processor core of the one or more physical machines. The set of processor executable instructions can include, e.g., instructions for carrying out a method for negotiating a solution to a joint optimization problem.

In the system environment of FIG. 1, the coordinator agent 110 can execute a protocol for negotiating a solution to a joint optimization problem. The protocol involves sending, by the coordinator agent 110, a set of proposed constraints (i.e. constraint proposal C_{A}), and receiving, by the plurality of additional agents 120, the set of proposed constraints. The protocol further involves sending, by each of the plurality of additional agents 120, a set of counter-proposal constraints (i.e. constraint counter-proposal C_{A}′) that are additional constraints or constraints that are alternatives to one of more of the constraints in the set of proposed constraints. The coordinator agent 110 then receives each respective set of counter-proposal constraints sent by each respective one of the plurality of additional agents 120. Thereafter, the coordinator agent 110 determines a solution to the joint optimization problem that satisfies all constraints in the constraint proposal C_{A} and in each respective constraint counter-proposal C_{A}′. Finally, the coordinator agent 110 communicates, or transmits, the determined solution to each of the plurality of additional agents 120.

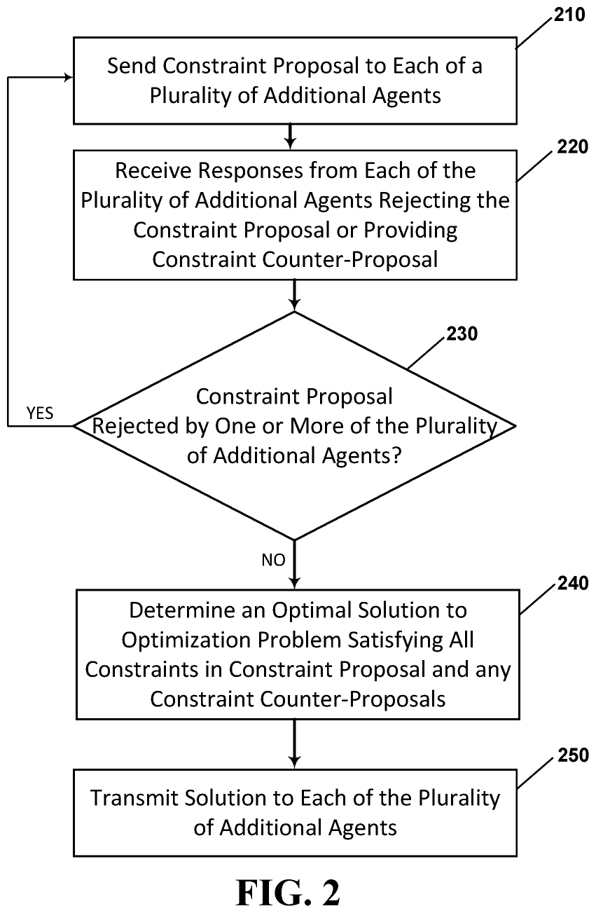

FIG. 2 is a flow chart illustrating a protocol for negotiating a solution to an optimization problem. The protocol illustrated in FIG. 2 can be executed by the coordinator agent 110 of FIG. 1. At 210, a coordinator agent (e.g. the coordinator agent 110) sends a constraint proposal C_{A} to each of a plurality of additional agents (e.g. the plurality of additional agents 120) involved in the optimization. The constraint proposal C_{A} encodes, for example, a set of tasks among which each agent is requested to execute a subset.

At 220, the coordinator agent receives, from each of the plurality of additional agents, a response to the constraint proposal C_{A} either rejecting the constraint proposal C_{A} or returning one or more further constraints to be satisfied, i.e. by providing a set of counter-proposal constraints (i.e. constraint counter-proposal C_{A}′) that are additional constraints or constraints that are alternatives to one of more of the constraints in the set of proposed constraints. Each respective one of the plurality of additional agents will reject the constraint proposal C_{A} if it will not accept any solution compatible with constraint proposal C_{A} (meaning, for example, that it will not execute any of the requested tasks). Alternatively, each respective one of the plurality of additional agents will return a constraint counter-proposal C_{A}′ if a solution compatible with constraint proposal C_{A} will be accepted if the solution additionally satisfies the additional or alternative constraints specified by the constraint counter-proposal C_{A}′ (for example, the agent is willing to execute at most 3 of the proposed tasks).

At 230, the coordinator agent, having received the responses from each of the plurality of additional agents, determines whether any respective one of the plurality of additional agents has rejected the constraint proposal C_{A}. If one or more of the plurality of additional agents has rejected the constraint proposal C_{A}, the protocol returns to 210 where the coordinator agent proposes a new constraint proposal C_{A} to each of the plurality of additional agents. Alternatively, if none of the plurality of additional agents has rejected the constraint proposal, the protocol proceeds to 240 where the coordinator agent determines an optimal solution satisfying all constraints of both C_{A} and C_{A}′. Thereafter, at 250, the coordinator agent transmits, or communicates, the solution to each of the plurality of additional agents.

FIG. 3 is a schematic diagram of an alternative environment in which a protocol for negotiating a solution to an optimization problem can be executed. In the alternative environment illustrated in FIG. 3, an agent user interface 310 is provided that enables a user 320 to communicate with the coordinator agent 110. In the environment illustrated in FIG. 3, the coordinator agent 110 includes a database that stores a list of translatable constraints and is configured to execute computer-executable instructions for determining which of a plurality of constraints of an optimization problem can be presented in a format understandable to a human user and for presenting such constraints in such format. In this manner, the coordinator agent 110 can present certain constraints to the human user in a manner that enables the human user to accept those constraints or make a counterproposal via the agent user interface 310.

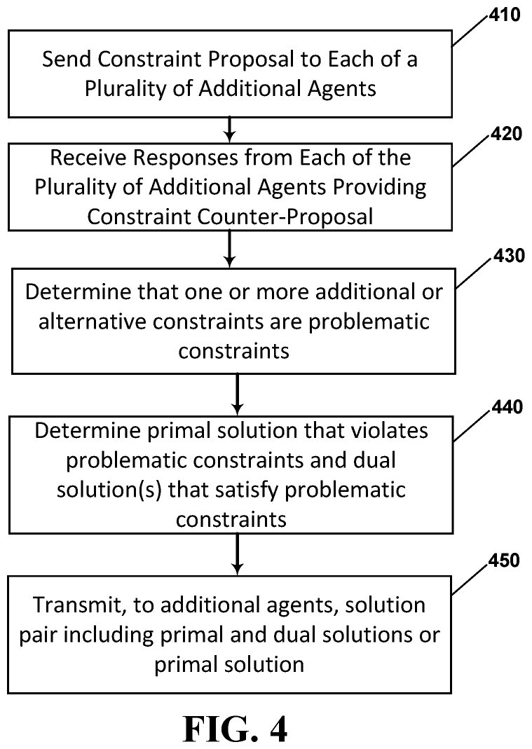

FIG. 4 is a flow chart illustrating an alternative protocol for negotiating a solution to an optimization problem. The protocol illustrated in FIG. 4 can be executed by the coordinator agent 110 of FIG. 1. At 410, a coordinator agent (e.g. the coordinator agent 110) sends a constraint proposal C_{A} to each of a plurality of additional agents (e.g. the plurality of additional agents 120) involved in the optimization. The constraint proposal C_{A} encodes, for example, a set of tasks among which each agent is requested to execute a subset. In some embodiments, the additional agents may already possess a definition of the multi-agent optimization problem that is to be solved. In other words, prior to receiving the constraint proposal C_{A} from the coordinator agent, the additional agents may already possess a definition of a set of variables X and a set of constraint predicates dom(X)→{true, false}(which must be satisfied by any feasible solution) that collectively characterize the multi-agent optimization problem. In such embodiments, the constraints in the constraint proposal C_{A} sent by the coordinator agent represent constraints proposed by the coordinator agent that are in addition to those in the set of constraint predicates dom(X)→{true, false} that characterize the multi-agent optimization problem. In such cases, the constraint predicates dom(X)→{true, false} that characterize the multi-agent optimization problem can represent technical or logical feasibility requirements and/or legal requirements, while the constraints in the constraint proposal C_{A} sent by the coordinator agent can represent parameters of a possible solution (e.g. restrictions on the form of the solution) requested or demanded by the coordinator agent. Alternatively, the constraint proposal C_{A} sent by the coordinator agent at 410 may include a definition of a set of variables X, the constraint predicates dom(X)→{true, false} that characterize the multi-agent optimization problem, and additional constraints requested or demanded by the coordinator agent.

At 420, the coordinator agent receives, from each of the plurality of additional agents A, a response to the constraint proposal C_{A} returning one or more further constraints to be satisfied, i.e. by providing a set of counter-proposal constraints (i.e. constraint counter-proposal C_{A}′) that are additional constraints or constraints that are alternatives to one of more of the constraints in the set of proposed constraints C_{A}. The constraints in a respective constraint counter-proposal C_{A}′ represent parameters of a possible solution (e.g. restrictions on the form of the solution) requested or demanded by a respective additional agent. In other words, a respective constraint counter-proposal C_{A}′ sent by a respective additional agent indicates that the respective additional agent will accept a solution compatible with constraint proposal C_{A} if the solution additionally satisfies the additional or alternative constraints specified by the constraint counter-proposal C_{A}′. However, the constraints in a respective constraint counter-proposal C_{A}′ cannot be alternatives to constraint predicates dom(X)→{true, false} that characterize the multi-agent optimization problem.

At 430, the coordinator agent determines that one or more additional or alternative constraints C* specified in one or more respective constraint counter-proposals C_{A}′ are problematic constraints, i.e. constraints that will have a detrimental impact on the desired optimization, e.g. unnecessarily lead to an increased value of a quantity to be minimized (such as total cost or total time to completion). At 440, the coordinator agent then determines, for each of the one or more constraints C*, (i) a primal solution (with one or more values v′ that violates a respective one of the one or more constraints C*) that represents an improved, or cheaper, alternative solution to any solution that might satisfy the respective one of the one or more constraints C*, and (ii) a dual solution to the original optimization problem (characterized by the set of variables X and the constraint predicates dom(X)→{true, false}), where the dual solution satisfies the respective one of the one or more proposed constraints C*.

At 450, the coordinator agent transmits, to each respective additional agent that requested each respective additional or alternative constraints C*, a solution pair including (i) the primal solution with the one or more values v′ that violate the respective constraint C*, and (ii) the dual solution to the original optimization problem (characterized by the set of variables X and the constraint predicate dom(X)→{true, false}), where the dual solution satisfies the respective constraint C*. The solution pair enables an additional agent to quickly and easily—and without expending significant computational resources-verify correctness of the coordinator agent's computations (i.e. that the primal solution with the one or more values v′ provides an optimization value, e.g. total cost, total emissions, that is superior to the best optimization value that could be achieved by a solution that satisfies the respective constraint C*) without the need to compute any primal or dual solution itself. At 450, the coordinator agents also transmits, to each additional agent that did not request any of the one or more constraints C*, the primal solution with the one or more values v′.

One or more embodiments of the invention provide advantages over prior art methods for solving multi-agent optimization problems by (i) enabling negotiation by transmitting constraint proposals, and (ii) enabling negotiation by transmitting dual solutions as certificates of optimality or suboptimality.

The manner in which transmission of dual solutions as certificates of optimality or suboptimality is illustrated by the following example. Consider, for example, a problem where a set of n tasks needs to be executed, and there two agents, agent 1 and 2. When agent 1 executes task i, nonnegative costs c_i1 have to be paid. The costs of agent 2 executing the task are defined as c_i2 accordingly. In an embodiment, the objective function is to minimize the total cost:

minimize x_11*c_11+ . . . +x_n1*c_n1+x_12*c_12+ . . . +x_n2*c_n2

where x_i1 is an indicator variable which represents the decision whether agent 1 will execute task 1 (x_i1=1) or not (x_i1=0); accordingly for agent 2.

As all tasks need to be executed by at least one agent, there is a constraint:

x_i1+x_i2≥1

for each task i=1 . . . n.

Furthermore, executing tasks requires time. Agent 1 executing task i requires time t_i1; accordingly for agent 2. Each agent has some total time budget available, respectively denoted T_1 and T_2. The constraint not to exceed the time budget can be formulated by the two constraints:

x_11*t_11+ . . . +x_n1*t_n1≤T_1x_12*t_12+ . . . +x_n2*t_n2≤T_2.

As this problem is a generalization of the well-known KNAPSACK problem, determining an optimal solution with today's hard- and software takes time exponential in the number of tasks.

Suppose that agent 1 proposes to solve either task 1 or task 2, or both. This proposal is expressed by the additional constraint

x_11+x_21≥1.

Assume that both the cost c_11 and the cost c_21 are very large compared to other costs, where c_21 is even larger than c_11. Agent 2, in order to prove to Agent 1 that the proposal will lead to a large cost, presents to Agent 1 the following dual solution:

c_11*(1−x_11−x_21) for the additional constraint; and

0 for all other constraints.

For the additional constraint, the function satisfies the requirement of dual solutions that the function value is 0 or lower in case the constraint is satisfied. For the other constraints, this requirement is trivially satisfied.

Applying the dual solution, the problem is now to minimize:

x_11*c_11+ . . . +x_n1*c_n1+x_12*c_12+ . . . +x_n2*c_n2+c_11*(1−x_11−x_21)

without any constraints to satisfy.

The new objective function is linear, with the coefficient of x_11 being 0, the coefficient of x_21 being (c_21-c_11>0), the other coefficients being the same as in the original objective function, and the constant term being c_11. As all coefficients are nonnegative, the minimum solution is obtained by setting all x-variables to zero; thus the minimum value is c_11, the cost of agent 1 executing task 1.

Computing the coefficients of the new problem and verifying that all coefficients are nonnegative can be done in linear time; thus the lower bound c_11 can be verified by agent 1 in linear time given the dual solution obtained from agent 2.

Embodiments of the invention provide, inter alia, the following advantages over prior art methods for solving multi-agent optimization problems:
Ability to systematically negotiate solutions to multi-agent optimization problems by proposing constraints is more efficient than directly negotiating solutions because less communication rounds are required. Furthermore, communicating constraints still leaves the freedom to select any solution the satisfies the constraints, without being limited to a single solution that has been proposed.
Verifying optimality and suboptimality via dual certificates is computationally much more efficient than verifying this through re-solving, by each individual agent, the whole optimization problem.
Agents do not need to reveal their individual objectives and system state; instead they can express their conditions for cooperation in the form of constraints.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for negotiating a solution to a joint optimization problem, the method comprising:
transmitting a machine-readable constraint proposal specifying one or more machine-readable constraints to each of a plurality of agents;
receiving, from each of the plurality of agents, a machine-readable counter-proposal specifying one or more additional or alternative machine-readable constraints;
computing a solution compatible with each of the one or more machine-readable constraints and the one or more additional or alternative machine-readable constraints; and
communicating, to each of the plurality of agents via a machine-to-machine protocol, the computed solution.

2. The method of claim 1, further comprising:
receiving, from a respective one of the plurality of agents, a respective machine-readable counter-proposal specifying a machine-readable problematic constraint,
wherein the machine-readable problematic constraint is a constraint that will unnecessarily increase a cost of the solution to the joint optimization problem, and
wherein the problematic constraint is a constraint that is in addition to the one or more additional or alternative constraints.

3. The method of claim 2, wherein the computed solution does not satisfy the machine-readable problematic constraint.

4. The method of claim 3, further comprising transmitting, to the respective one of the plurality of agents, a dual solution that includes the machine-readable problematic constraint.

5. The method of claim 4, wherein the dual solution enables the respective one of the plurality of agents to verify, without computing a primal solution to the optimization problem, that the problematic machine-readable constraint will unnecessarily increase a cost of the solution to the joint optimization problem.

6. The method of claim 5, wherein the dual solution is a certificate of the non-existence of a solution that both satisfies the machine-readable problematic constraint and has a decreased cost relative to the computed solution.

7. The method of claim 4, wherein the dual solution defines a set of functions that can be added to the used to simplify the joint optimization problem to a simplified joint optimization problem.

8. The method of claim 7, wherein determining a primal solution the joint optimization problem has a time dependence on a number of tasks to be performed that is exponential, and
wherein determining a primal solution to the simplified joint optimization problem has a time dependence on a number of tasks to be performed that is linear.

9. The method of claim 1, wherein the joint optimization problem is defined by a set of variables, an objective function to be minimized, and a set of constraint predicates.

10. The method of claim 9, wherein the one or more machine-readable constraints of the machine-readable constraint proposal are in addition to constraints of the set of constraint predicates.

11. The method of claim 1, further comprising translating at least a portion of the one or more machine-readable constraints into a human-readable format and displaying the translated constraints on a user interface.

12. The method of claim 11, further comprising receiving user input via the user interface and translating the user input into at least a portion of the one or more additional or alternative machine-readable constraints.

13. The method of claim 11, wherein the at least a portion of the one or more machine-readable constraints that is translated into a human-readable format is selected based on a list of translatable constraints stored at a database.

14. A non-transitory computer readable medium having instructions stored thereon for carrying out a method for negotiating a solution to a joint optimization problem, the method comprising:
transmitting a machine-readable constraint proposal specifying one or more machine-readable constraints to each of a plurality of agents;
receiving, from each of the plurality of agents, a machine-readable counter-proposal specifying one or more additional or alternative machine-readable constraints;
computing a solution compatible with each of the one or more machine-readable constraints and the one or more additional or alternative machine-readable constraints; and
communicating, to each of the plurality of agents via a machine-to-machine protocol, the computed solution.

15. A coordinator agent configured to negotiate a solution to a joint optimization problem, the coordinator agent comprising:
one or more processors configured to:
transmit a machine-readable constraint proposal specifying one or more machine-readable constraints to each of a plurality of agents;
receive, from each of the plurality of agents, a machine-readable counter-proposal specifying one or more additional or alternative machine-readable constraints;
compute a solution compatible with each of the one or more machine-readable constraints and the one or more additional or alternative machine-readable constraints; and
communicate, to each of the plurality of agents via a machine-to-machine protocol, the computed solution.
